(19) United States
(12) Patent Application Publication
(10) Pub. No.: US 2014/0165813 A1
(43) Pub. Date: Jun. 19, 2014

(54) CABLE PEELING AND CUTTING DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: CHENG ZHANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/098,542

(22) Filed: Dec. 6, 2013

(30) Foreign Application Priority Data
Dec. 14, 2012 (CN) 2012105413872

(51) Int. Cl. H02G 1/12

(52) U.S. Cl. CPC H02G 1/127
USPC 83/862

(57) ABSTRACT

A cable peeling and cutting device comprises a mounting plate, a cutting mechanism, a first peeling member, and a second peeling member. The cutting mechanism comprises a driver mounted on the mounting plate, a first and second connecting rod connected to the driver, a first connecting member connected to the first connecting rod, and a second connecting member connected to the second connecting rod. First cutters, second cutters, and third cutters are mounted to the first connecting member and the second connecting member. A distance between two third cutters is less than a distance between two first cutters and two second cutters. The first and second peeling members are movably mounted on the mounting plate and capable of moving towards and away from third cutters each other.

### BACKGROUND

1. Technical Field

The present disclosure relates to cable peeling and cutting devices, and particularly to a cable peeling and cutting device for automatically peeling and cutting a cable having a cover layer and a fiber.

2. Description of Related Art

Devices for automatically peeling and cutting cables may use a screw rod to drive a cutter to peel or cut cables. However, the screw rod drives the cutter relatively slowly. Thus, it costs a large amount of time to peel or cut the cables. In addition, the screw rod may be damaged easily after cutting and peeling a large number of cables.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of an embodiment of a cable peeling and cutting device comprising a cutting assembly.

FIG. 2 is similar to FIG. 1, but viewed from another aspect.

FIG. 3 is an exploded, isometric view of the cable peeling and cutting device shown in FIG. 1.

FIG. 4 is an isometric view of the cutting assembly of the cable peeling and cutting device shown in FIG. 1.

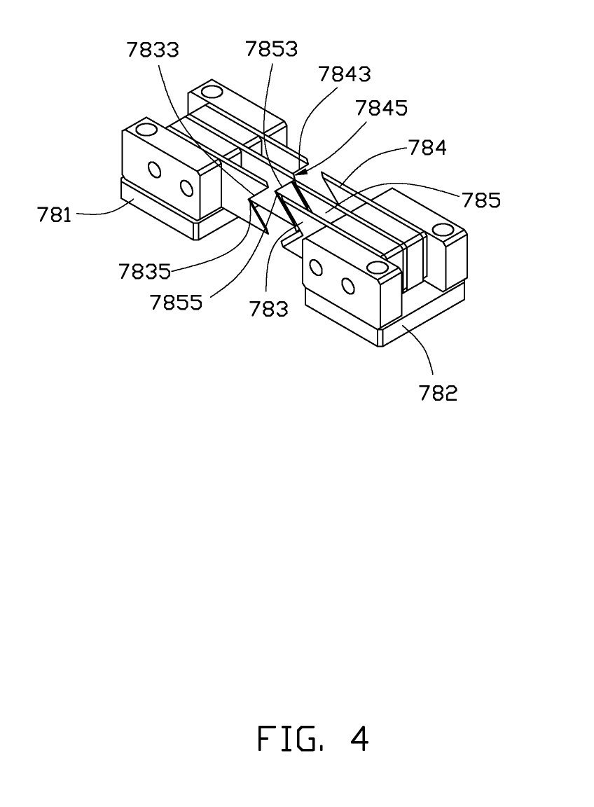

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

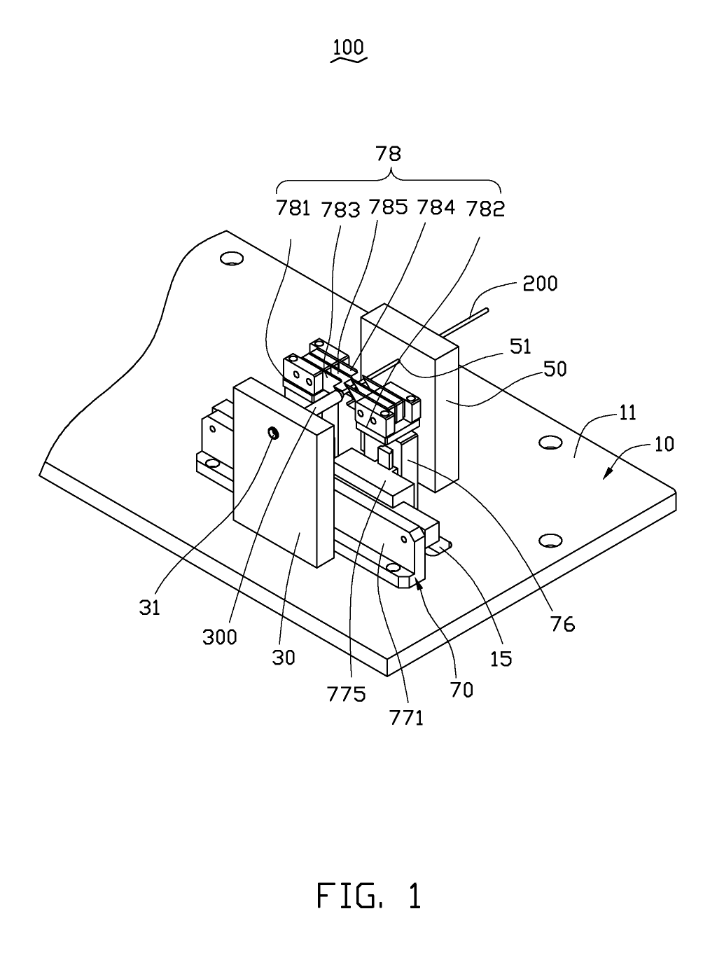

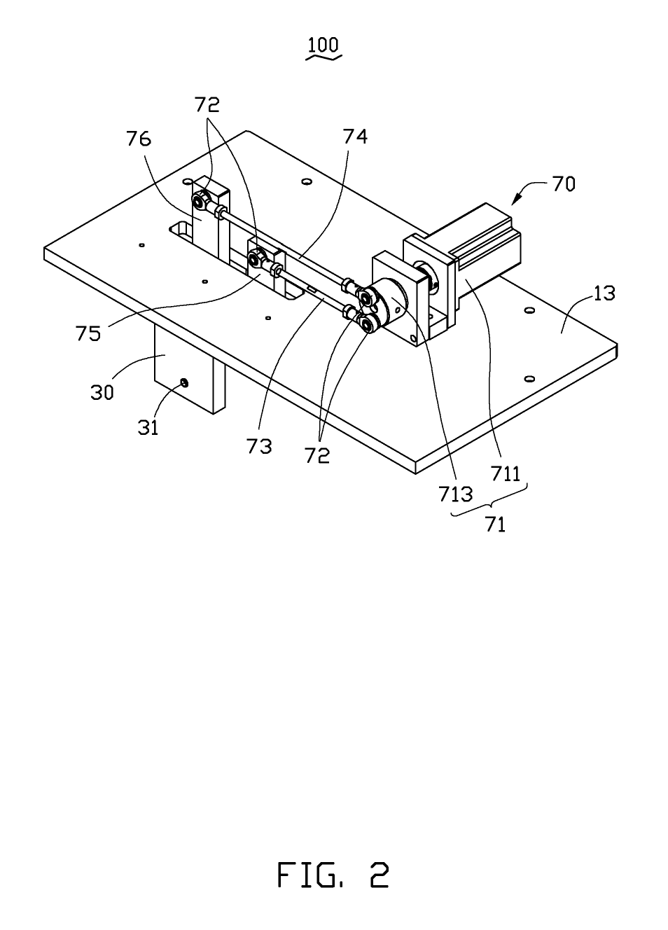

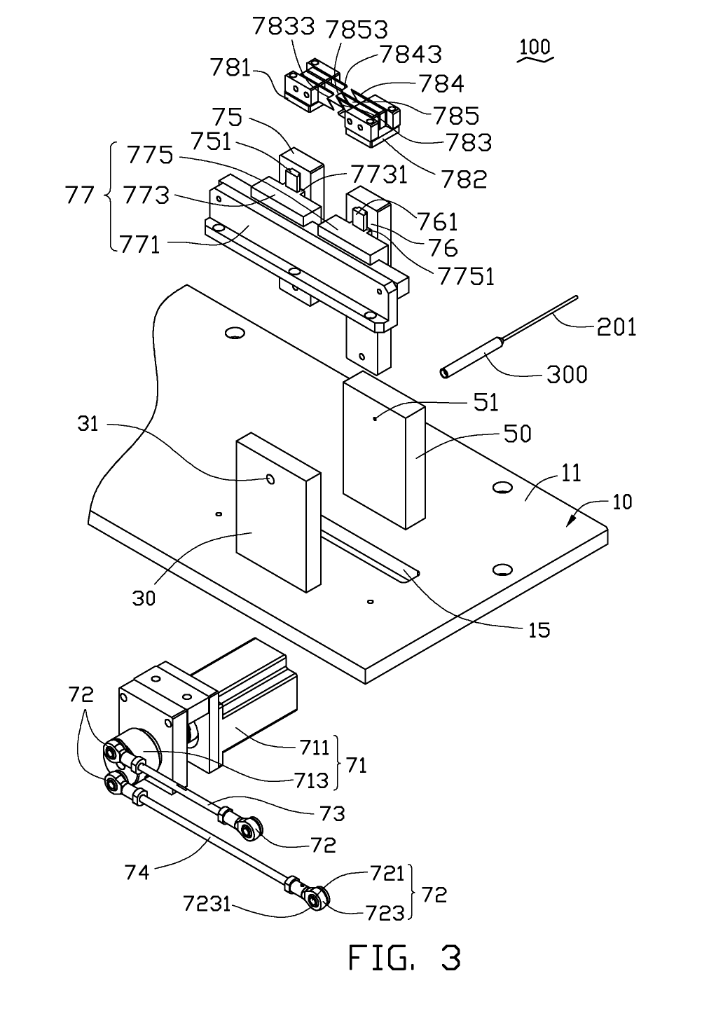

FIGS. 1 through 3 show one embodiment of a cable peeling and cutting device 100. The cable peeling and cutting device 100 comprises a mounting plate 10, a first peeling member 30, a second peeling member 50, and a cutting mechanism 70. The first peeling member 30, the second peeling member 50, and the cutting mechanism 70 are mounted on the mounting plate 10. The first peeling member 30 is configured to hold a cable holding member 300 in which a cable 200 is received therein. The second peeling member 50 is configured to hold the cable 200 therethrough. The cutting mechanism 70 is configured to cut a cover layer 201 and a fiber (not shown) partially covered by the cover layer 201 of the cable 200. The first peeling member 30, the second peeling member 50, and the cutting mechanism 70 cooperatively peel the cover layer 201 and the fiber off from the cable 200.

The mounting plate 10 comprises a top surface 11 and a bottom surface 13. The mounting plate 10 defines a slot 15 through the top surface 11 and the bottom surface 13. The first peeling member 30 and the second peeling member 50 are movably mounted on the top surface 11 of the mounting plate 10. The first peeling member 30 and the second peeling member 50 are located at opposite sides of the slot 15. The first peeling member 30 and the second peeling member 50 are movable towards or away from each other by drivers (not shown in figures). The first peeling member 30 defines a first holding hole 31 for receiving the cable holding member 300. The second peeling member 50 defines a second holding hole 51 for receiving the cable 200. The first holding hole 31 is aligned with the second holding hole 51, and an imaginary line connecting the first holding hole 31 and the second holding hole 51 is substantially parallel to the top surface 11 of the mounting plate 10.

The cutting mechanism 70 comprises a driver 71, four movable members 72, a first connecting rod 73, a second connecting rod 74, a first connecting member 75, a second connecting member 76, a sliding assembly 77, and a cutting assembly 78. The driver 71 is mounted to the bottom surface 13 of the mounting plate 10. A movable member 72 is connected to each end of the first connecting rod 73 and each end of the second connecting rod 74, respectively. One end of the first connecting rod 73 and one end of the second connecting rod 74 are connected to the driver 71 by the corresponding movable members 72, respectively. The other end of the first connecting rod 73 is connected to the first connecting member 75 by one corresponding movable member 72, and the other end of the second connecting rod 74 is connected to the second connecting member 76 by another corresponding movable member 72. The first connecting member 75 and the second connecting member 76 are received through the slot 15. The sliding assembly 77 is mounted on the top surface 11 of the mounting plate 10. The first connecting member 75 and the second connecting member 76 are vertically slidably connected to the sliding assembly 77. The cutting assembly 78 is mounted to the first connecting member 75 and the second connecting member 76, and positioned above the mounting plate 10 for cutting the cover layer 201 and the fiber of the cable 200.

The driver 71 comprises a driving body 711 and a driving end 713 connected to the driving body 711. The driving body 711 is mounted to the bottom surface 13 of the mounting plate 10 and located adjacent to the slot 15. The driving end 713 is located adjacent to an end of the slot 15. The driving body 711 rotates the driving end 713.

Each movable member 72 comprises a fixing portion 721 and a movable portion 723 rotatably sleeved around the fixing portion 721. The movable portion 723 defines a substantially spherical receiving groove 7231 according or corresponding to a shape of the fixing portion 721. The fixing portion 721 is substantially spherical and movably received in the receiving groove 7231. One fixing portion 721 connected to the first connecting rod 73 and one fixing portion 721 connected to the second connecting rod 74 are mounted to the driving end 713 substantially symmetrically about a central rotation axis of the driving end 713 of the driver 71. In the illustrated embodiment, the movable members 72 are spherical plain bearings.

Opposite ends of the first connecting rod 73 are connected to the driving end 713 and the first connecting member 75, respectively, by two of the movable members 72. Opposite ends of the second connecting rod 74 are connected to the driving end 713 and the second connecting member 76, respectively, by the other two of the movable members 72. The first connecting rod 73 is substantially parallel to the second connecting rod 74. A length of the second connecting rod 74 is longer than a length of the first connecting rod 73.

The first connecting member 75 and the second connecting member 76 are received through the slot 15. An end of the first connecting member 75 away from the first connecting rod 73 and an end of the second connecting member 76 away from the second connecting rod 74 are positioned above the top surface 11 of the mounting plate 10. A first guiding rail 751 is formed on a sidewall of the first connecting member 75 along a lengthwise direction of the first connecting member 75. A second guiding rail 761 is formed on a sidewall of the second connecting member 76 along a lengthwise direction of the second connecting member 76.

The sliding assembly 77 comprises a guiding member 771, a first sliding member 773 slidably engaged with the guiding member 771, and a second sliding member 775 also slidably engaged with the guiding member 771. The guiding member 771 is fixed on the top surface 11 of the mounting plate 10 and positioned adjacent to the slot 15. The first sliding member 773 and the second sliding member 775 are slidably sleeved on the guiding member 771. The first sliding member 773 is mounted to the first connecting member 75, and the second sliding member 775 is mounted to the second connecting member 76. The first sliding member 773 and the second sliding member 775 slide along the guiding member 771 substantially parallelly to the mounting plate 10. A first sliding portion 7731 extends from a side of the first sliding member 773, and slidably engages with the first guiding rail 751. Thus, the first sliding portion 7731 allows the first connecting member 75 to slide along a lengthwise direction of the first connecting member 75. A second sliding portion 7751 extends from a side of the second sliding member 775, and slidably engages with the second guiding rail 761. Thus, the second sliding member 7751 allows the second connecting member 76 to slide along a lengthwise direction of the second connecting member 76.

The cutting assembly 78 comprises a first fixing member 781 and a second fixing member 782. The first fixing member 781 and the second fixing member 782 are plates. The first fixing member 781 is fixed to an end of the first connecting member 75 away from the first connecting rod 73. The second fixing member 782 is fixed to an end of the second connecting member 76 away from the second connecting rod 74. The first fixing member 781 and the second fixing member 782 each comprise a first cutter 783, a second cutter 784, and a third cutter 785. Each first cutter 783 forms a substantially V-shaped cutting edge 7833. The cutting edges 7833 face each other, and an imaginary line between a plurality of vertices 7835 of the cutting edges 7833 is substantially parallel to the mounting plate 10. Each second cutter 784 forms a substantially V-shaped cutting edge 7843. The cutting edges 7843 face each other, and an imaginary line between a plurality of vertices 7845 of the cutting edges 7843 is substantially parallel to the mounting plate 10.

Each third cutter 785 is located between one corresponding first cutter 783 and one corresponding second cutter 784. The each third cutter 785 forms a substantially V-shaped cutting edge 7853. The cutting edges 7853 face each other, and an imaginary line between a plurality of vertices 7855 of the cutting edges 7853 is substantially parallel to the mounting plate 10. A distance between the vertices 7855 of the cutting edges 7853 is smaller than a distance between the vertices 7835 of the cutting edges 7833 and smaller than a distance between the vertices 7845 of the cutting edges 7843. The distance between the vertices 7835 of the cutting edges 7833 is substantially equal to the distance between the vertices 7845 of the cutting edges 7843. Therefore, the first cutters 783 and the second cutters 784 cut the cover layer 201, and the third cutters 785 cut the fiber of the cables 200.

In assembly, the first peeling member 30 and the second peeling member 50 are mounted on the top surface 11 of the mounting plate 10, and the driver 71 is mounted to the bottom surface 13 of the mounting plate 10. The first connecting rod 73 connects the driving end 713 to the first connecting member 75, and the second connecting rod 74 connects the driving end 713 to the second connecting member 76. The guiding member 771 of the sliding assembly 77 is mounted on the top surface 11 of the mounting plate 10. The first sliding member 773 is mounted to the first connecting member 75, and the second sliding member 775 is mounted to the second connecting member 76. The first fixing member 781 is mounted to the first connecting member 75, and the second fixing member 782 is mounted to the second connecting member 76. The first cutters 783, the second cutters 784, and the third cutters 785 are mounted correspondingly to the first mounting member 781 and the second mounting member 782, such that the third cutter 785 is located between the first cutter 783 and the second cutter 784.

In use, the cable holding member 300 is fixed to the first peeling member 30. The cable 200 is received through the first cutters 783, the second cutters 784, and the third cutters 785, and one end of the cable 200 away from the cable holding member 300 is fixed to the second peeling member 50. The driving body 711 rotates the driving end 713 back and forth at a high speed, which causes the first connecting member 75 and the second connecting member 76 to move towards and away from each other at a high speed. As the first connecting member 75 and the second connecting member 76 move toward and away from each other, the engagement between the first and second guiding rails 751, 761 and the first sliding portion 7731 and the second sliding portions 7751, respectively, prevent the first and second connecting members 75, 76 from moving perpendicularly relative to the mounting plate 10. Simultaneously, the first sliding member 773 and the second sliding member 775 slide along the guiding member 771 towards and away from each other. When the first connecting member 75 and the second connecting member 76 move toward each other, the cutting edges 7853 of the third cutters 785 cut the cover layer 201 and the fiber of the cable 200, and the first cutters 783 and the second cutters 784 cut portions of the cover layer 201. Then, the first peeling member 30 and the second peeling member 50 are driven to move away from each other, so that the cut portions of the cover layer 201 at opposite sides of the third cutter 785 are cut off from the cable 200. When the cutting is done or finished, the first peeling member 30 and the second peeling member 50 are returned to an original state, respectively.

Because the driver 71 drives the first connecting member 75 and the second connecting member 76 to move parallelly relative to the mounting plate 10, and the first peeling member 30 and the second peeling member 50 are driven to move toward and away from the slot 15, the first cutters 783, the second cutters 784, and the third cutters 785 cooperatively cut and remove the cover layer 201 of the cable 200. Therefore, the above cutting-motions are simpler and faster. Since the respective structural elements of the cable peeling and cutting device 100 are arranged at opposite sides of the mounting plate 10, a required size of the cable peeling and cutting device 100 is reduced. A structure of the cable peeling and cutting device 100 is simpler, and a cutting action is also simpler. Thus, the cable peeling and cutting device 100 has a longer usage life.

In an alternative embodiment, the first fixing member 781, the second fixing member 782, and the sliding assembly 77 can be omitted, such that the first cutters 783, the second cutters 784, and the third cutters 785 are directly mounted to the first connecting member 75 and the second connecting member 76. The second peeling member 50 and the second cutter 784 can be omitted, such that only the cover layer 201 of the cable 200 at one side of the third cutters 785 is cut when the driving body 711 rotates the driving end 713.

It is believed that the present embodiments and their advantages will be understood from the foregoing description, and it will be apparent that various changes may be made thereto without departing from the spirit and scope of the embodiments or sacrificing all of its material advantages.

What is claimed is:

1. A cable peeling and cutting device, comprising:
a mounting plate comprising a top surface and a bottom surface, and defining a slot through the top surface and the bottom surface, respectively;
a cutting mechanism comprising:
a driver mounted to the bottom surface of the mounting plate,
four movable members,
a first connecting rod connected to the driver by a first one of the four movable members,
a second connecting rod connected to the driver by a second one of the four movable members,
a first connecting member connected to the first connecting rod by a third one of the four movable members, and received through the slot,
a second connecting member connected to the second connecting rod by a fourth one of the four movable members,
a pair of first cutters mounted to the first connecting member and the second connecting member, respectively, and positioned opposite to each other, each first cutter comprising a cutting edge, and
a pair of third cutters mounted to the first connecting member and the second connecting member, respectively, and positioned opposite to each other, each third cutter comprising a cutting edge, a distance between cutting edges of the pair of third cutters being smaller than a distance of cutting edges of the pair of first cutters; and
a first peeling member movably mounted on the top surface of the mounting plate, and capable of moving towards or away from the slot.

2. The cable peeling and cutting device of claim 1, wherein the driver comprises a driving body and a driving end rotatably connected to the driving body, the first connecting rod and the second connecting rod are connected to the driving end by the first one of the four movable members and the second one of the four movable members, respectively, and are positioned symmetrically relative to a rotation axis of the driving end.

3. The cable peeling and cutting device of claim 1, wherein each of the four movable members comprises a fixing portion and a movable portion rotatably sleeved on the fixing portion, the movable portion defines a receiving groove, the fixing portion is movably received in the receiving groove, the fixing portion of the first one of the four movable members and the fixing portion of the second one of the four movable members are mounted to the driving end of the driver, the movable portion of the first one of the four movable members is connected to the first connecting rod, and the movable portion of the second one of the four movable members is connected to the second connecting rod, the fixing portion of the third one of the four movable members is connected to the first connecting member, and the fixing portion of the fourth one of the four movable members is connected to the second connecting member, the movable portion of the third one of the four movable members is connected to the first connecting rod, and the movable portion of the fourth one of the four movable members is connected to the second connecting rod.

4. The cable peeling and cutting device of claim 3, wherein the fixing portion is substantially spherical, and the receiving groove is a substantially spherical groove matching to a shape of the fixing portion.

5. The cable peeling and cutting device of claim 1, wherein the four movable members are spherical plain bearings.

6. The cable peeling and cutting device of claim 1 further comprising a sliding assembly, wherein the sliding assembly comprises a guiding member, a first sliding member and a second sliding member, the guiding member is mounted on the top surface of the mounting plate, the first sliding member and the second sliding member are vertically slidably mounted on the guiding member, and are capable of sliding along the guiding member towards or away from each other, the first sliding member is slidably mounted to the first connecting member along a direction perpendicular to the mounting plate, and the second sliding member is slidably mounted to the second connecting member along a direction perpendicular to the mounting plate.

7. The cable peeling and cutting device of claim 1, wherein the cutting mechanism further comprises a first fixing member and a second fixing member, the first fixing member is mounted to the first connecting member, the second fixing member is mounted to the second connecting member, the pair of first cutters are mounted on the first fixing member and the second fixing member, respectively, the pair of third cutters are mounted on the first fixing member and the second fixing member, respectively.

8. The cable peeling and cutting device of claim 1 further comprising a second peeling member and a pair of second cutters, wherein the second peeling member is movably mounted on the top surface of the mounting plate, the first peeling member and the second peeling member are positioned at opposite sides of the slot, the pair of second cutters are positioned on the first connecting member and the second connecting member, respectively.

9. The cable peeling and cutting device of claim 8, wherein the first peeling member defines a first holding hole, the second peeling member defines a second holding hole aligned to the first holding hole.

10. The cable peeling and cutting device of claim 8, wherein a first connecting rod is shorter than the second connecting rod.

11. A cable peeling and cutting device, comprising:
a mounting plate;
a cutting mechanism comprising:
a driver mounted on the mounting plate,
four movable members,
a first connecting rod connected to the driver by a first one of the four movable members,
a second connecting rod connected to the driver by a second one of the four movable members,
a first connecting member connected to the first connecting rod by a third one of the four movable members,
a second connecting member connected to the second connecting rod by a fourth one of the four movable members,
a pair of first cutters mounted to the first connecting member and the second connecting member, respectively, and positioned opposite to each other, each first cutter comprising a V-shaped first cutting edge, the V-shaped first cutting edge comprising a vertex,
a pair of second cutters mounted to the first connecting member and the second connecting member, respectively, and positioned opposite to each other, each second cutter comprising a V-shaped second cutting edge, the V-shaped second cutting edge comprising a vertex, and
a pair of third cutters mounted to the first connecting member and the second connecting member, respectively, and positioned opposite to each other, each third cutter positioned between the corresponding one of the pair of first cutters and the corresponding one of the pair of second cutters, each third cutter comprising a V-shaped third cutting edge, the V-shaped second cutting edge comprising a vertex, a distance between vertices of the V-shaped cutting edges of the pair of third cutters smaller than a distance between vertices of the V-shaped first cutting edges of the pair of first cutters, and smaller than a distance between vertices of the V-shaped second cutting edges of the pair of second cutters;
a first peeling member movably mounted on the mounting plate, and capable of moving towards or away from the pair of first cutters; and
a second peeling member movably mounted on the mounting plate, and capable of moving towards or away from the pair of second cutters.

12. The cable peeling and cutting device of claim 11, wherein the driver comprises a driving body and a driving end rotatably connected to the driving body, the first connecting rod and the second connecting rod are connected to the driving end by the first one of the four movable members and the second one of the four movable members, respectively, and are positioned symmetrically relative to a rotation axis of the driving end.

13. The cable peeling and cutting device of claim 11, wherein each of the four movable members comprises a fixing portion and a movable portion rotatably sleeved on the fixing portion, the movable portion defines a receiving groove, the fixing portion is movably received in the receiving groove, the fixing portion of the first one of the four movable members and the fixing portion of the second one of the four movable members are mounted to the driving end of the driver, the movable portion of the first one of the four movable members is connected to the first connecting rod, and the movable portion of the second one of the four movable members is connected to the second connecting rod, the fixing portion of the third one of the four movable members is connected to the first connecting member, and the fixing portion of the fourth one of the four movable members is connected to the second connecting member, the movable portion of the third one of the four movable members is connected to the first connecting rod, and the movable portion of the fourth one of the four movable members is connected to the second connecting rod.

14. The cable peeling and cutting device of claim 13, wherein the fixing portion is substantially spherical, and the receiving groove is a substantially spherical groove matching to a shape of the fixing portion.

15. The cable peeling and cutting device of claim 11, wherein the four movable members are spherical plain bearings.

16. The cable peeling and cutting device of claim 11 further comprising a sliding assembly, wherein the sliding assembly comprises a guiding member, a first sliding member and a second sliding member, the guiding member is mounted on the mounting plate, the first sliding member and the second sliding member are vertically slidably mounted on the guiding member, and are capable of sliding along the guiding member towards or away from each other, the first sliding member is slidably mounted to the first connecting member along a direction perpendicular to the mounting plate, and the second sliding member is slidably mounted to the second connecting member along a direction perpendicular to the mounting plate.

17. The cable peeling and cutting device of claim 11, wherein the cutting mechanism further comprises a first fixing member and a second fixing member, the first fixing member is mounted to the first connecting member, the second fixing member is mounted to the second connecting member, the pair of first cutters are mounted on the first fixing member and the second fixing member, respectively, the pair of second cutters are mounted on the first fixing member and the second fixing member, respectively, the pair of third cutters are mounted on the first fixing member and the second fixing member, respectively.

18. The cable peeling and cutting device of claim 11, wherein the first peeling member defines a first holding hole, the second peeling member defines a second holding hole aligned to the first holding hole.

19. The cable peeling and cutting device of claim 11, wherein the mounting plate defines a slot, the first connecting member and the second connecting member are inserted through the slot, respectively.

20. The cable peeling and cutting device of claim 11, wherein a first connecting rod is shorter than the second connecting rod.
